(19) United States
(12) Patent Application Publication
(10) Pub. No.: US 2001/0052778 A1
(43) Pub. Date: Dec. 20, 2001

(54) Device for detecting and locating insulation defects

(76) Inventor: Paul Samuel Smith, West Valley, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/873,824

(22) Filed: Jun. 4, 2001

Related U.S. Application Data
(60) Provisional application No. 60/209,942, filed on Jun. 7, 2000.

(51) Int. Cl. H04B 3/46; H01H 31/02

(52) U.S. Cl. 324/541

(57) ABSTRACT

A system and method that detects and locates defects in solid insulation is disclosed. The system and method solves difficult detection and location problems, such as when the break is not close enough to another exposed conductor to fail a high-voltage breakdown test. The system tests insulated conductors using a high-voltage breakdown tester, a connection integrity tester capable of identifying unintended connections, a means of connecting the tester to the conductors, and an inflatable bladder that causes a conductive material attached to the two testers to conform to the shape of the conductor. The inflatable bladder may be used as part of a gas or liquid dispensing system for enhancing the effectiveness of the test.

### RELATED APPLICATIONS

This application claims the benefit of earlier-filed U.S. patent application Ser. No. 60/209,942, filed Jun. 7, 2000, for “Device for Detecting and Locating Insulation Defects,” which is incorporated herein by reference.

### BACKGROUND OF THE INVENTION

1. Field of the Invention

The present invention relates to devices and methods used to detect and locate defects in electric circuitry. More specifically, the present invention relates to devices and methods that locate defects in solid insulation covering electrical circuitry and wiring.

2. Description of Related Art

Presently, the industry commonly coats conductive wire or bundled cables with a solid insulating material to provide electrical isolation between wires. In addition, the insulation material also helps provide thermal insulation, strain relief, protection against mechanical damage and abrasion, chemical and corrosion protection, sealing, and limit signal distortion. The thickness and dielectric characteristics of these solid insulation materials are specifically chosen to maintain isolation, limit shock danger and signal distortion, while increasing power or signal delivery efficiencies seen in the conductor. As wire is used for a wide variety of purposes, there are differences in the type of insulation used. For example, a data communication cable may use a Teflon® FEP coat to promote transmission and provide physical protection.

Occasionally the solid insulation surrounding a conductive wire or cable is damaged or defective and exposes the conductors. These defects in the insulation may be very small and difficult to see. Defects, such as cracking, often result from mechanical stresses imposed upon conductors having stiff or brittle insulation. Embrittlement of the solid insulation is a result of the normal aging of the insulation. Aging is often accelerated by operation at high temperatures over an extended period of time. The mechanical stresses may be caused by movement, short-circuit currents, thermal expansion and contraction of the conductors, and vibration. While the dielectric strength of insulation is generally not significantly reduced by brittleness alone, loss of isolation can result from the development of cracks. For this reason, close inspection of insulation should be made at frequent intervals, and repairs made as necessary.

More specifically, it is important to know if insulating material surrounding a conductive wire or cable has been pierced or broken. Such a failure could be a precursor to an electrical system failure in whatever system the wire or cable is installed. For example, failure in the solid wire insulation could cause an aircraft or other vehicle to lose control, which may result in an accident. It is therefore desirable to find damaged insulation before a failure occurs so that appropriate repairs can be made.

Unfortunately, the defect and fault detection methods presently available are counterproductive to the defect detection process. For example, high voltage breakdown tests are commonly used to find defects in solid insulation, but the necessary applied voltage required to find these insulation defects is often several times higher than the voltage rating of the insulation. Thus, performing the high voltage breakdown test itself can actually destroy or weaken the insulation and wiring being analyzed, thereby creating defects in the solid insulation. What is needed is a method of locating defects without requiring the use of high voltage. Alternatively, a method is needed that substantially reduces the voltage required to detect and locate defects and electrical isolation faults in the electrical pathways.

High voltage is commonly used to find defects in solid insulation, but it is impractical to find defects when a single conductor's insulation is damaged using this technique because an arc has to be detected between at least two conductors. As such the high voltage breakdown test is only useful if a conductor or charged electrode is in the vicinity of the insulation defect. Often this defect is imperceptible, making it very difficult to intentionally place a conductor near the defect. What is needed is a device that brings one or more added conductor(s) in proximity to insulation failures, thus making the defects detectable using standard techniques.

### SUMMARY OF THE INVENTION

The present invention provides a system and method of detecting and locating defects in solid insulation. The invention performs this detection by holding conductive surfaces against the conductors via a bladder or diaphragm. The present invention has been developed in response to the current state of the art, and in particular, in response to these and other problems and needs that have not been fully or completely solved by currently available sensor or electronic detection applications. The present invention reduces the voltage required to detect and locate an insulation defect when performing insulation tests. These qualities are primarily accomplished through conforming and pressing conductive surfaces against and around the conductors being tested via the injection of a gas into an inflatable bladder. The present invention may include at least one conductive surface or electrode for evaluating the connectors or electrical paths for defects in solid insulation of a cable or wire harness. The invention may also include a tester to find insulation defects, the tester being capable of performing any one of several standard tests between conductors. The present invention may also include one or more inflatable bladders that are used to hold the conductive surfaces against the conductor.

One or more conductive surfaces or electrodes are electrically attached to, placed against, or made part of an inflatable bladder. The bladder is inflated after being brought near or against the conductor. In one embodiment, the conductor is placed near or against the bladder before inflation. In another embodiment, the conductor is placed near or against the bladder after full or partial inflation. In either embodiment, once inflated the bladder presses the electrodes against the conductor.

These added electrodes are used in conjunction with the conductive material in the conductor to determine the presence of insulation failures by means of various insulation tests, such as resistance measurements, time-domain reflectometry, standing wave tests, or high-voltage breakdown tests. Specifically, if an added electrode makes physical contact with conductive material in the conductor through damage in the insulation, a resistance measurement, standing wave tests, or time-domain reflectometry can be used to identify and locate the fault. If an added electrode doesn't make physical contact to conductive material in the conductor through the damage in the insulation, a high-voltage breakdown test can still be used to cause an arc to occur between the added electrode and the exposed conductive material in the conductor.

One or more added electrodes may locate the position of the insulation fault since the arc or short-circuit will occur between the conductor with damaged insulation and the nearest added electrode. The added electrode and bladder configuration may also be moved along the cable to test different sections of the conductor.

The system and method of the present invention finds defects in solid insulation by using conductive surfaces or electrodes held against the conductor via an inflatable bladder configuration. The system and method may use one or more standard insulation tests including resistance measurements, time-domain reflectometry, standing wave tests, high-voltage breakdown tests, and the like. The system and method uses one or more conductors that are attached to, placed against, or made part of an inflatable bladder for the purpose of finding the location of insulation defects. The portable inflatable bladder may be attached to a rigid or semi-rigid containment structure that can be moved along the conductor to test different regions of the conductor at different times. The system and method of the invention finds defects in solid insulation by using conductive surfaces held against the conductor using a portable inflatable bladder that may be slid between a conductor and any adjacent physical structure such as a wall, pipe, or bulkhead. The system and method may also use multiple bladders to test multiple sections of a conductor.

The inflatable bladder may also be used as part of a gas or liquid dispensing system for enhancing the effectiveness of the test. In this configuration, the gas or liquid is introduced into the test area via the bladder and is used to increase the sensitivity of the test to insulation defects.

### BRIEF DESCRIPTION OF THE DRAWINGS

In order that the manner in which the above recited and other advantages and objects of the invention are obtained, a more particular description of the invention briefly described above will be rendered by reference to specific embodiments thereof, which are illustrated in the appended drawings. Understanding that these drawing depict only typical embodiments of the invention and are not therefore to be considered to be limiting of its scope, the invention will be described and explained with additional specificity and detail through the use of the accompanying drawings in which:

FIG. 1 illustrates one embodiment of an inflatable bladder in accordance with the present invention;

FIG. 2 illustrates one embodiment of an inflatable bladder, similar to the one shown in FIG. 1, used with an insulation defect detection system in accordance with one embodiment of the present invention;

FIG. 3 illustrates an alternative embodiment of an inflatable insulation detection system with a flexible bladder containment fixture; and

FIG. 4 illustrates one embodiment of a portable inflatable insulation detection system.

### DETAILED DESCRIPTION OF THE PREFERRED EMBODIMENTS

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment.

Furthermore, the particular features, structures, or characteristics may be combined in any suitable manner in one or more embodiments. In the following description, numerous specific details are provided, such as examples of inflatable bladders, test gases, various gas delivery and containment systems, different electrode probes, insulation testers, types of insulation, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “circuitry,” “cables,” or “wires” mean conductors with or without solid insulation. Conductors provide electrical paths for electrical power or signals. A conductor is often created out of conductive materials. Typically conductive materials are a class of material incapable of supporting electric stress, such that when a charge is given to a conductive material it spreads to all parts of the material. Exemplary conductive materials include aluminum, copper, platinum, gold, silver, chromium, tungsten, nickel, combinations thereof, and the like. Exemplary conductors or electrical paths that may be tested by the present invention include cables, connectors, wire harness, backplanes, printed circuit boards, circuitry, wires, or other similar electrical apparatus. While the figures only illustrate two conductors, one skilled in the relevant art will recognize that the system may also be practiced with multiple conductors.

Additionally, reference throughout this specification to “gas” means a state of matter in which the molecules are practically unrestricted by cohesive forces. Ambient air is an exemplary gas. Depending on the embodiment, the gas may be selected to help obtain a desired electric effect. For example, some configurations attempt to confine electric behavior between the conductors and the system's conductive surfaces. These embodiments may employ gases with an electron affinity to limit or dampen electric activity within the inflatable bladder.

Several other embodiments use a “test gas” in conjunction with the bladder to induce signs of insulation failure. In this context, the test gas is a gas that requires a lower voltage gradient for ionization than ambient air. These test gases do not have significant electron affinity and are referred to herein as electropositive. As such, the electropositive test gases exhibit an ionization point, breakdown, flashover, arcing, or corona discharge at a lower voltage gradient relative to ambient air. Exemplary test gases useful with the present invention include neon, helium, argon, xenon, krypton, radon, and combinations thereof. Helium, for example, has been shown to require a lower voltage gradient than air requires and is an excellent choice for the test gas. The noble test gases listed above have the added benefit that they are generally not chemically combining even during an arc. Other electropositive gases, which may or may not chemically combine with conductors and/or insulation may also be used.

“Ionization” is the process by which neutral atoms or groups of atoms become electrically charged, either positively or negatively, by the loss or gain of electrons. An “ionized test gas” denotes the state of the test gas when atoms or groups of atoms within the test gas have become charged. The test gases may initially be introduced into the test area in a non-ionized state, but the test gas still requires a lower inducing voltage than ambient air for the occurrence of a noticeable voltage event, such as arcing or corona discharge.

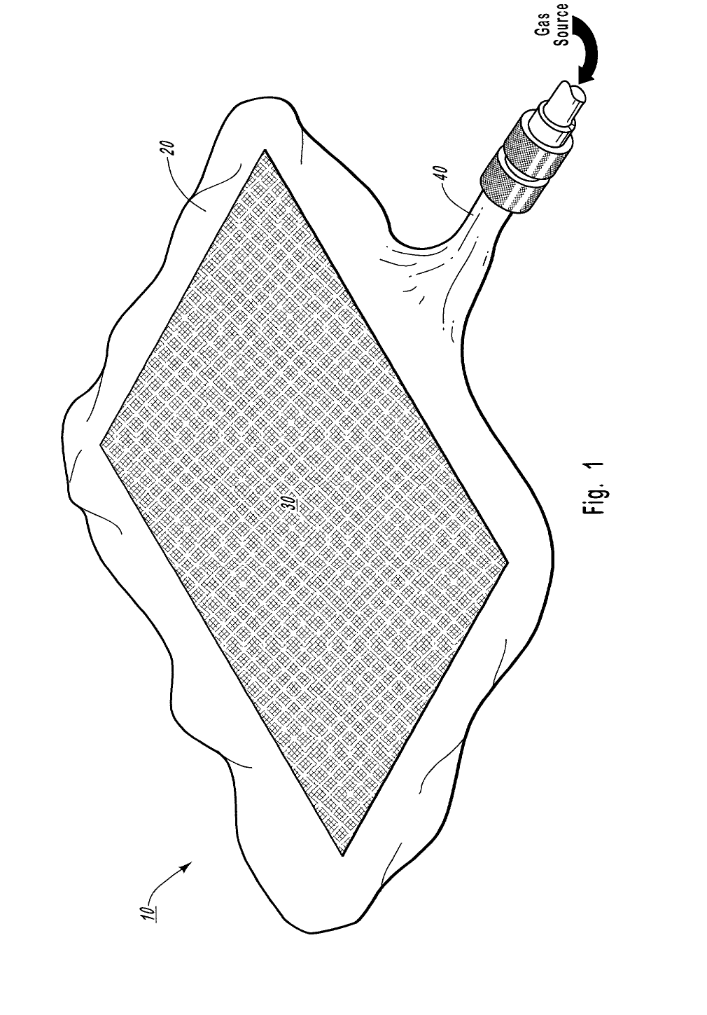

Reference is first made to FIG. 1 illustrating an inflatable bladder 10. The bladder 10 includes a retentive film membrane 20, a conductive surface 30 disposed on the film layer 20, and a tubular inlet 40. The retentive film membrane 20 includes overlapping body portions that define a cavity. In one embodiment, the membrane restricts the exodus of gas molecules from the cavity, causing the bladder 10 to inflate when gas is introduced into the cavity via the tubular inlet 40.

The membrane 20 may be constructed from a wide variety of materials and is preferably puncture resistant. The membrane 20 may also include multiple film layers bonded together. Exemplary membrane 20 materials used in creating the bladder 10 include a wide variety of balloon materials in commercial use today, such as nylon, latex, rubber, and plastics. Each of these balloon materials have many acceptable molecular configurations, such as polyethylene (for example, as producible from the resin “ELVAX 3120” marketed by DuPont E. I. De Nemours & Co). While many of the membrane 20 materials used in the construction of the expandable bladder do not stretch, some configurations allow for stretching during the inflation process. The material being used in the membrane 20 characteristically determines the layer thickness. For example, polyethylene film membranes have a preferred thickness in the range of one (1.0) to three (3.0) mils. Furthermore, a membrane 20 may be created from multiple material layers bonded together increasing the overall thickness of the membrane on the bladder 10.

The conductive surface 30 is a conductor that can be charged with an inducing voltage so that a corona discharge or arc occurs between insulation defects and the conductive surface 30. The conductive surface 30 is typically a deformable layer that can conform to the shape of a wire being tested. This ability helps ensure that physical contact will be made between the conductive surface 30 and any insulation defects on the wire in the test area. The conductive surface 30 is generally constructed from conductive materials, but may use numerous constructions or configurations. For example, the conductive surface 30 may be conductive mesh patches, metalized film layers, electrodes, bare wires, or the like. In one embodiment, the conductive surface 30 is integrated into the membrane 20. Another embodiment places the conductive surface within the bladder 10, using the membrane to insulate the conductive surface from unintended contact.

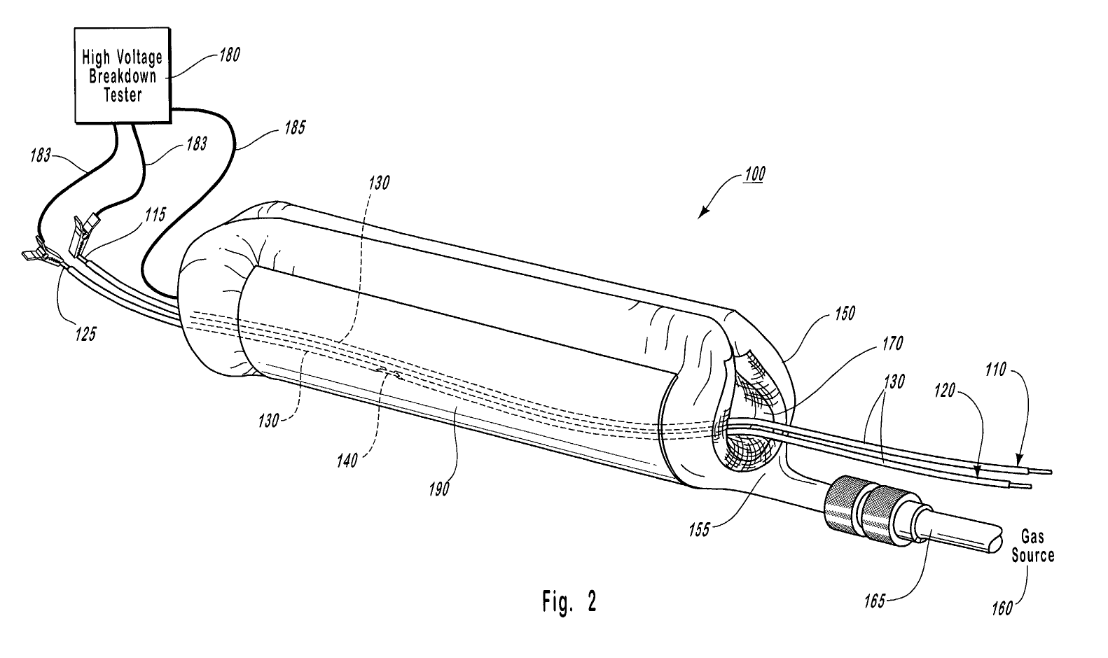

Reference is next made to FIG. 2 illustrating an insulation detection and location system 100. The system 100 is useful in testing the integrity of wires 110, 120. More specifically, the system 100 tests solid insulation 130 around conductors 115, 125 by detecting and locating insulation defects, such as an exposed conductor 140. The system 100 includes an inflatable bladder 150, a gas source 160, a conductive surface 170, an insulation tester 180, and a containment fixture 190. The bladder 150 is connected via an inlet 155 to a feed tube 165 from the gas source 160. Conductive surfaces 170, such as copper mesh patches or electrodes, associated with the bladder 150 are electrically connected to the insulation tester 180 via at least one wire 185. The system 100 also includes wires 190 that electrically connect the insulation tester 180 to the conductors 115, 125. While FIG. 2 only illustrates two wires, one skilled in the relevant art will recognize, however, that the system may also be practiced with multiple wires.

As previously mentioned, the wires 110 and 120 generally include at least one coating of solid insulation 130 to prevent arcing between neighboring conductors. Insulation 130 applied directly over conductors 115 and 125 is often called the primary insulation, since it determines most of the insulation properties of an individual wire. Sheath insulation, commonly called the jacket, brings several conductors together in a single cable configuration. The sheath insulation predominately offers mechanical protection. However, it does affect the electrical performance of the cable. Exemplary insulation materials used in data communication cables include FHF film (Teflon® FEP), Halar ECTFE, Compounded PVC, and other polymer resins. Other insulation systems for conductors include impregnated fiber products, laminated and molded products, polyester film, polyamide film, adhesive tapes, composite products, insulating paper, mica products, fiberglass sleeving, fiberglass tape, polyester non-woven fabrics, thermoplastic systems (asphalt-mica), thermosetting systems (polyester-mica or epoxymica), and other compounds know to one of skill in the art. Defects in these insulation systems are often difficult to see, which make them particularly dangerous. The present invention tests the insulation integrity without subjecting the insulation to damaging voltage levels. Furthermore the conductive surfaces of the bladder 150 can help pinpoint the location of unseen insulation defects.

The system 100 of the present invention detects and locates defects 140 in solid insulation 130. The system 100 performs this detection by holding conductive surfaces against or around the wires 110,120. More specifically, the containment fixture 190 forces the bladder 150 or diaphragm to inflate around the surfaces of the wires 110, 120. If restricted by the containment fixture 190, the bladder 150 and the conductive surfaces associated with the bladder 150 conform and press against and around the wires 110,120 being tested once inflated via the injection of a gas from the gas source 160.

As previously mentioned, the bladder 150 may include at least one conductive surface or electrode for evaluating the wires 110, 120 for defects 140 in the solid insulation 130. These conductive surfaces may be sensitive, flexible electrodes or copper mesh patches affixed to the surface of the bladder 150. In one embodiment, the conductive surface includes a conductive mesh interwoven into the bladder. By disposing the conductive mesh over the entire exterior surface, the entire bladder 150 is conductive. The present invention may also include one or more inflatable bladders that are used to customize the insulation tests and more effectively hold the conductive surfaces against the conductor being tested.

When the bladder 150 inflates, it conforms the conductive surfaces against the wires 110, 120 being tested, the insulation tester 180 is capable of performing any one of several standard insulation tests, such as resistance measurements, time-domain reflectometry, standing wave tests, or high-voltage breakdown tests. The insulation tester 180 performs the tests between conductors 115, 125 and the conductive surfaces 170 associated with the bladder 150 according to the type of contact achieved between the conductors 115, 125 and tester 180. In one embodiment, if an added electrode 170 makes physical contact with conductive material in one of the conductors 115, 125 through a defect or damage 140 in the insulation 130, a resistance measurement, standing wave test, or time-domain reflectometry can be used to identify and locate the fault.

Resistance measurements are made between the conductors 115, 125 and copper mesh patches or electrodes 170 associated with the bladder 150. If the measurements indicate that a short circuit has been detected, the failure is known to be in the region of the copper mesh patches 170 where it was detected. If the system 100 is using multiple electrodes 170, the detection of the short circuit may also give away the location of the insulation failure. After the resistance measurement test is complete, a high-voltage may be applied between the copper mesh patch 170 and the conductors 115, 125. If an arc occurs, the fault is known to be in the region of the copper mesh patch 170 where the arc occurred.

If the electrodes 170 do not make physical contact with conductor 125 in the damaged wire 120, a high-voltage breakdown test can be used to cause an arc to occur between the added electrode 170 and the exposed conductor 140 in the wire 120. One or more added electrodes 170 associated with the bladder 150 may locate the position of the insulation fault since the arc or short-circuit will occur between the wire 120 with damaged insulation 140 and the nearest added electrode 170. The added electrode 170 and bladder configuration may also be moved along the wires 110, 120 to test different sections of the conductor.

In the case of the high voltage breakdown test, high voltage is applied between the conductors 110, 120 via wires 190 electrically attached to a high-voltage breakdown tester 180. The high voltage breakdown tester 180 includes a high voltage supply and a current-sense module. The high-voltage breakdown tester 180 also tests the isolation of the electrical paths created by conductors 115, 125 for electrical signals. The tester 180 is used to determine the amount of electrical insulation between conductors 115 and 125. The high voltage breakdown tester 180 performs a “hipot test” by applying a high voltage (AC or DC) potential between conductors 115 and 125 and sensing the current flow (AC or DC). The high voltage supply may provide between about 50 Volts and about 15,000 Volts. The amount of current sensed or the current change over time is used to determine the quality of insulation or isolation between conductors 115 and 125. If multiple conductors are being tested for insulation/isolation, patterns may be used to apply the voltage between conductors such that all conductors to be tested for insulation/isolation defects have voltage applied between them at some time during the test.

The effectiveness of the high voltage breakdown test can be dramatically improved by filling the bladder 150 with a test gas. The lower voltage gradient of the test gas when compared to ambient air helps the system to check the solid insulation around conductors at a lower voltage potential. The test gas is directed or confined within the bladder 150 such that it envelops the area to be tested. When high voltage is applied between conductors 110, 120 and the conductive surfaces are exposed and physically close, an arc occurs through the test gas and the insulation tester 180 records a current surge. Prior to arcing, the added test gas exhibits a very high electrical resistance. Once a sufficient voltage gradient is applied, the test gas “breaks down” or ionizes and has very low effective resistance. With the lower resistance it is easier for an electrical arc to form between the conductors 115, 125 and the conductive surface 170. In an effort to promote this effect at a lower voltage, the voltage gradient for the breakdown of the test gas used in the present invention is substantially lower than for ambient air. Exemplary test gases useful with the present invention include neon, helium, argon, xenon, krypton, radon, and combinations thereof.

In one embodiment the system 100 uses a conductive containment fixture 190 that conforms the inflatable bladder 150 as the bladder 150 fills with a test gas. In one configuration, the containment fixture 190 is a rigid component of the bladder 150. Another configuration inserts a separate bladder 150 into the containment fixture 190 prior to inflation of the bladder 150. The inducing test voltages are then applied between the conductors 115, 125 and the conductive containment fixture 190. In this embodiment, it is important to use a test gas to lower the voltage levels required for testing, because the separation between the fixture 190 and the conductors 115,125 is greater than in the other described embodiments, which use a conductive surface 170.

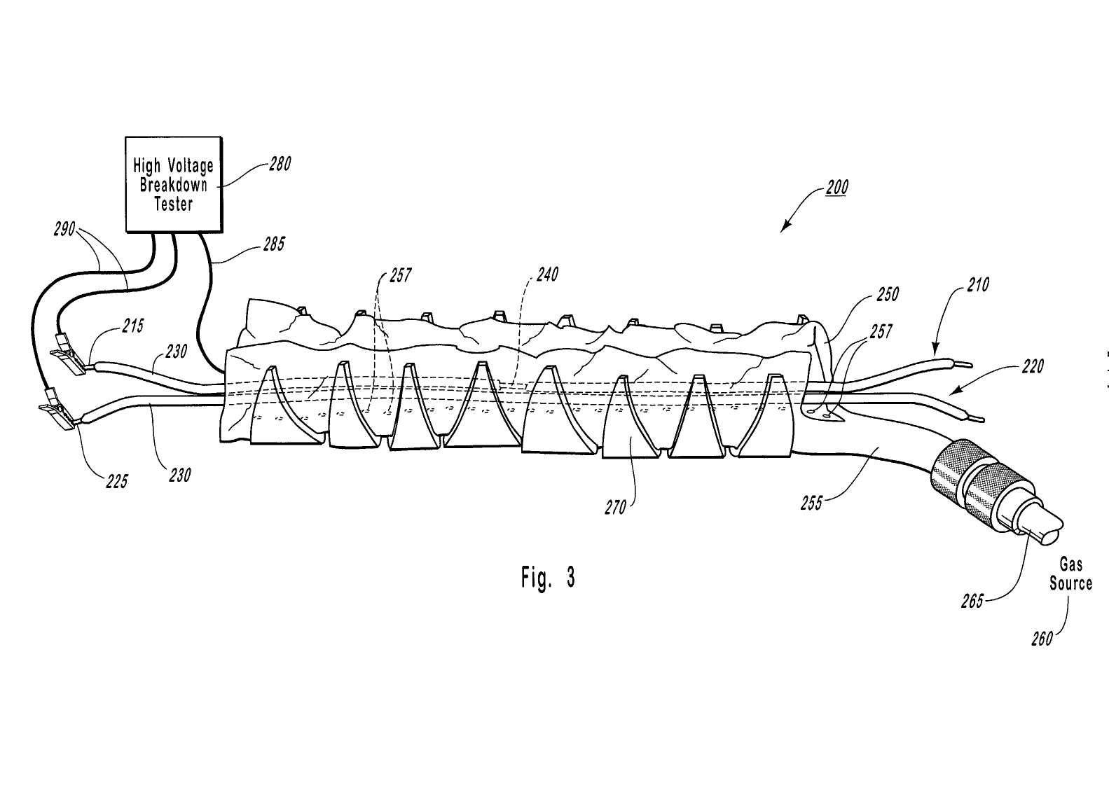

Reference is next made to FIG. 3 illustrating a flexible test gas insulation detection and location system 200. The system 200 tests the integrity of wires 210, 220. More specifically, the system 200 tests solid insulation 230 around the conductors 215 and 225, detecting and locating insulation defects, such as exposed conductor 240.

The system 200 includes a conductive inflatable bladder 250, a test gas source 260, a flexible containment fixture 270, and an insulation tester 280. Using an electropositive test gas in conjunction with the insulation tester 280 and the conductive bladder 250 allow the system 200 to perform high-voltage breakdown testing at considerably lower test voltages than ambient air. The test gas is delivered to the bladder 250 via an inlet 255 from a feed tube 265 from the test gas source 260. Upon inflation of the conductive bladder 250, the test gas begins to fill the spaces adjacent the wires 210, 220 via orifices 257. Once the concentration of test gas in the test area is sufficient to lower the voltage gradient, the tester 280 may perform a high voltage breakdown test. The conductive bladder 250 is electrically connected to the insulation tester 280 via at least one wire 285. The system 200 also includes wires 290 that electrically connect the insulation tester 280 to the conductors 210, 220.

The conductive inflatable bladder 250 may be made from various inflatable materials, such as plastic coated with a metalized copper, rip stop nylon, foam rubber, and the like. One embodiment uses a flexible stretching barrier to retain the test gas and apply pressure on the wires 210, 220. Just as with the illustrated embodiment in FIG. 2, the system 200 may apply a variety of insulation tests to the conductors depending on the type of contact between the bladder 250 and the conductors 210, and 220. The insulation tests include resistance measurements, time-domain reflectometry, standing wave tests, high-voltage breakdown tests, and the like.

The flexible containment fixture 270 provides the system 200 with useful mobility, while maintaining the primary fixture function of retaining the bladder 250. The fixture 270 accomplishes this retention in a manner that compresses the bladder 250 against conductors 210 and 220. The mobility allows the system 200 to be used along curvatures in the conductors without requiring the conductors to be straightened. The flexible containment fixture 270 is preferably constructed from an insulating material so that it does not electrically interfere with the bladder 250.

An additional advantage of the system 200 is the ability to synchronize the testing with the release of the test gas. In fact, the tester 280 may conduct a purity test between various electrodes in the bladder 250 that provide calibrated arc gaps to determine the concentration of the test gas in the test area.

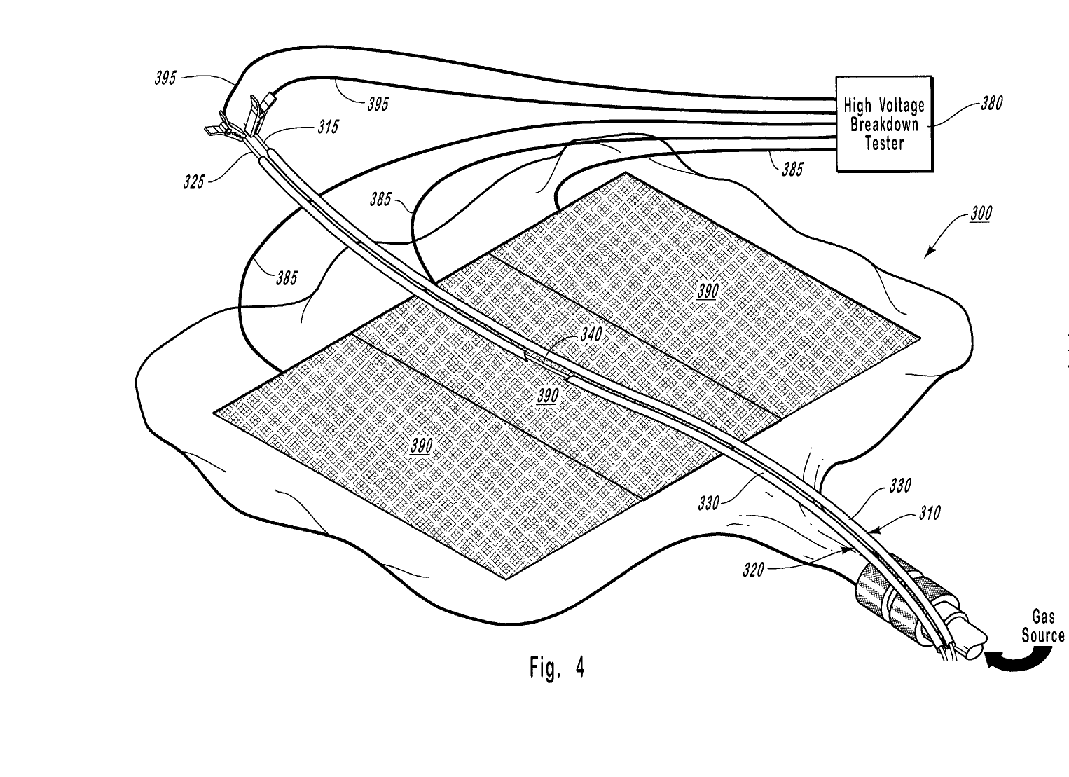

FIG. 4 illustrates a portable flat insulation detection and location system 300. The system 300 can be used to wrap around the wires 310, 320 to test their electrical integrity. More specifically, the system 300 tests the solid insulation 330 around the conductors 315 and 325, detecting and locating insulation defects, such as exposed conductor 340. The system 300 includes a selectively defigurable inflatable bladder 350, a compressed air source 360, and an insulation tester 380. The conductive surfaces may be embodied as conductive sheets 390. The conductive sheets 390 are electrically connected to the insulation tester 380 via at least one wire 385. The system 300 also includes wires 395 that electrically connect the insulation tester 380 to the conductors 310, 320.

Using the selectively defigurable portable bladder 350, the illustrated embodiment may be wrapped around or placed behind the conductors 310, 320 prior to inflation. The compressed air or gas is delivered to the bladder 350 via an inlet 355 from a feed tube 365 from the gas source 360. Upon inflation of the bladder 350, the support and pressure from bladder 350 force the conductive sheets 390 to fill the open spaces adjacent to the wires 310, 320 and conform to the surface of the wires 310 and 320. In one embodiment, the bladder 350 is wrapped around the wires 310, 320 prior to inflation. The bladder 350 is secured closed so that the subsequent inflation predominately forces the conductive sheets 390 to conform to the wires 310 and 320 on the interior of the system 300. Another embodiment allows the bladder 350 to be slid between wires 310, 320 and any adjacent physical structure such as a wall, pipe, or bulkhead prior to inflation. In one embodiment, the bladder 350 is transparent thereby making visible any corona activity around the solid insulation 330.

After inflation, the tester 380 determines what type of contact is made between the exposed conductor 340 and the conductive sheets 390. Specifically, if the conductive sheets 390 make physical contact with conductor 325 in the wire 320 through damage 340 in the insulation, a resistance measurement, standing wave tests, or time-domain reflectometry can be used to identify and locate the fault. If conductive sheets 390 do not make physical contact to conductor 325 in the wire 320 through the damage 340 in the insulation, a high-voltage breakdown test can still be used to create an arc between the added electrode 390 and the exposed conductor 340 in the wire 320. One or more conductive sheets 390 may locate the position of the insulation fault since the arc or short-circuit will occur between the wire 320 with damaged insulation 340 and the nearest conductive sheet 390. The selectively defigurable bladder configuration of system 300 may also be moved along the wire to test different sections of the wires 310, 320.

As with the other illustrated embodiments, the system 300 may also be used in hazardous fuel rich environments at a substantially reduced risk of harm. By reducing the voltage necessary to detect and locate insulation defects, the system 300 also reduces the likelihood of an errant spark igniting the fuel. Furthermore, in the wrap around configuration, system 300 contains the arcing within the folds of the inflatable bladder 350.

In summary, a system and method of the present invention finds defects in solid insulation by using conductive surfaces or electrodes held against a conductor via an inflatable bladder configuration. The system and method uses one or more standard insulation tests including resistance measurements, time-domain reflectometry, standing wave tests, high-voltage breakdown tests, and the like. In one embodiment, the system and method uses the inflatable bladder as part of a gas or liquid dispensing system where the gas or liquid is used to increase the sensitivity of the defect testing to insulation defects. The system and method uses one or more conductors that are attached to, placed against, or made part of an inflatable bladder for the purpose of finding the location of insulation defects. The system and method finds defects in solid insulation by using conductive surfaces held against a conductor using a portable inflatable bladder that may be attached to a rigid or semi-rigid structure that can be moved along the conductor to test different regions of the conductor at different times. The system and method finds defects in solid insulation by using conductive surfaces held against the conductor using a portable inflatable bladder that may be slid between a conductor and any adjacent physical structure such as a wall, pipe, or bulkhead. The invention may also use multiple bladders to test multiple sections of a conductor.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired to be secured by United States Letters Patent is:

1. A process of locating electrical insulation defects in wires, the process comprising:
inserting an inflatable bladder that expands to press against the wires upon inflation in a test area;
inflating the bladder to conform to the shape of a section of the wires;
introducing an electrode into the test area;
applying a detection voltage to the wires and the electrode; and
detecting electrical insulation defects in the wires through an insulation test.

2. The process as recited in claim 1, wherein the detection electrode includes multiple electrically isolated conductive surfaces, each conforming to the wires.

3. The process as recited in claim 1, wherein the detection voltage is an inducing voltage that causes arcing to occur between an exposed conductor and the detection electrode.

4. The process as recited in claim 1, wherein the electrode is integrated into the bladder.

5. The process as recited in claim 4, wherein more than one electrode is integrated into the bladder, the electrode providing positional information about detected insulation failures.

6. The process as recited in claim 1, wherein the insulation test is selected from the group consisting of high voltage breakdown tests, resistance measurements, standing wave tests, and time domain reflectometry tests.

7. The process as recited in claim 1, wherein the insulation test is a high-voltage breakdown test when the inflated bladder does not make physical contact with the wire.

8. The process as recited in claim 1, wherein the bladder includes multiple gas chambers to help conform to various surfaces of the wires.

9. The process as recited in claim 1, further comprising inflating the bladder with a test gas having a lower voltage gradient than ambient air.

10. A method of inducing arcing during insulation testing of electrical circuitry, said method comprising:
placing an inflatable bladder around the circuitry;
inflating the bladder such that the bladder conforms around the electrical circuitry; and
testing insulation for electrical defects.

11. The method as recited in claim 10, wherein testing insulation further comprises determining the presence of insulation failures through performing at least one of resistance measurements, time-domain reflectometry (TDR), standing wave tests, and high-voltage breakdown tests.

12. The method as recited in claim 10, wherein the inflatable bladder is transparent making visible any corona discharge activity around said solid insulation.

13. The method as recited in claim 10, further comprising injecting a test gas having an electrical breakdown voltage less than ambient air into the bladder.

14. The method as recited in claim 10, wherein the inflatable bladder is electrically conductive.

15. The method as recited in claim 14, wherein conductive surfaces of the inflated bladder make physical contact with an exposed conductor of the circuitry allowing the location of the exposed conductor to be identified using at least one of resistance measurements, standing wave tests, or time-domain reflectometry.

16. The method as recited in claim 14, wherein conductive surfaces of the inflated bladder are used to perform a high voltage breakdown test, causing arcing between the conductive surfaces and the exposed conductor in the conductor.

17. The method as recited in claim 10, wherein the bladder is flexible and conforms to the curvature of the circuitry.

18. The method as recited in claim 10, further comprising synchronizing the injection of the test gas with applying an electrical breakdown voltage less than that required in ambient air into said bladder to induce arcing in said test gas.

19. The method as recited in claim 10, further comprising releasing the test gas upon inflation of the bladder into a cavity surrounding the electrical circuitry.

20. A system for finding insulation defects in conductors, the system comprising:
an insulation tester to perform at least one insulation test on the conductors
a conductive test surface electrically attached to the insulation tester; and
an inflatable bladder holding the conductive test surface and configured to position the conductive test surface against the conductors.

21. The system as recited in claim 20, wherein at least one insulation test is selected from the group consisting of a high voltage breakdown test, resistance measurement, standing wave test, time domain reflectometry test, and combinations thereof.

22. The system as recited in claim 20, wherein the insulation tester is a high-voltage breakdown tester.

23. The system as recited in claim 20, wherein the inflatable bladder comprises at least two chambers adjustably inflatable to conform the conductive test surface to the conductor.

24. The system as recited in claim 20, further comprising a containment fixture selectively communicating with the bladder for increasing the pressure on the bladder as it is inflated.

25. The system as recited in claim 24, wherein the containment fixture is conductive.

26. The system as recited in claim 24, wherein the containment fixture is flexibly segmented to conform to curvature in the conductors.

27. The system as recited in claim 20, further comprising a gas distribution system comprising:
a gas source; and
a tube connecting the gas source to a inlet to the bladder.

28. The system as recited in claim 27, wherein the gas source supplies pressurized gas.

29. The system as recited in claim 27, wherein the gas source inflates the bladder with an electropositive test gas.

30. The system as recited in claim 29, wherein the bladder includes orifices for distributing the test gas adjacent to the conductors.

31. A system for testing insulated wires, the system comprising:
an inflatable bladder that conforms to the shape of the wires;
an insulation tester, comprising a high-voltage breakdown tester electrically connected to the bladder and a wire integrity tester capable of identifying defects in insulation on the wire;
a means of electrically connecting the testers to the wires; and
a conductive surface that is electrically connected to the insulation tester and in mechanical communication with the inflatable bladder, which causes the conductive surface to conform to the shape of the wires.

32. The system as recited in claim 31, further comprising:
a gas distribution system for inflating the bladder, the gas distribution system comprising a gas source and gas inlet tube; and
a bladder containment fixture connected to the bladder, the fixture forcing the bladder to inflate around the surfaces of the wires.

33. The system as recited in claim 31, wherein the bladder is configured to conform to the shape of a device upon inflation to detect insulation defects.

34. The system as recited in claim 33, wherein the bladder is configured to cause a conductive surface to conform to the shape of a section of a test area upon inflation.

35. The system as recited in claim 34, wherein the bladder is configured to cause multiple conductive surfaces to conform to the shape of a section of a test area upon inflation.

36. The system as recited in claim 31, wherein the bladder comprises at least two inflatable chambers for conforming the bladder to the shape of wires to detect insulation defects.
